(19) United States
(12) Patent Application Publication
(10) Pub. No.: US 2006/0153072 A1
(43) Pub. Date: Jul. 13, 2006

(54) Extending universal plug and play messaging beyond a local area network

(75) Inventors: Dennis Bushmitch, Somerset, NJ (US); Mahfuzur Rahman, South Brunswick, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 11/023,752

(22) Filed: Dec. 28, 2004

(51) Int. Cl. H04L 12/26

(52) U.S. Cl. 370/230

(57) ABSTRACT

A method architecture for extending universal plug and play (UPnP) beyond a local area network is presented. This method includes a mobile device proxying agents. The mobile device proxying agents translate messages between UPnP and session initiation protocol (SIP) formats and sessions.

### FIELD OF THE INVENTION

The invention relates to extending universal plug and play (UPnP) framework by means of UPnP message translation beyond a local area network (LAN). More specifically, the invention relates to translating a message between UPnP and session initiation protocol (SIP). The invention enables UPnP services and control points to become highly mobile.

### BACKGROUND OF THE INVENTION

UPnP technology establishes protocols that allow networked UPnP devices to interact with each other. Examples of devices that may be configured to implement UPnP protocols include computers, servers, printers, telephones, digital cameras, video recorders, Internet personal appliances, or personal digital assistants.

Typically, one UPnP device acts as a control point and another UPnP device exposes a service to that control point. A control point is an entity on the Local Area Network (LAN) that invokes an action on the service. For example, a control point may request a service to transmit data to the control point. Due to the nature of UPnP service discovery and eventing mechanisms, UPnP technology is limited in that it is only applied to UPnP devices that are connected to well-controlled LAN environment, where multicasting is supported.

While UPnP is limited to the LAN, Session Initiation Protocol (SIP) possesses no such limitations. SIP is a signaling protocol that will likely provide Internet Protocol (IP) multimedia services for the next generation of mobile devices. SIP provides application layer mobility. SIP also carries extensible markup language (XML), performs eventing, and includes security features that are presently lacking under UPnP. For example, SIP establishes, modifies, and terminates multimedia sessions, such as Internet telephony calls commonly referred to as voice of IP (VOIP). Through its features, SIP is an ideal protocol for device and service discovery and control frameworks, where application and user mobility are important.

While SIP is increasingly viewed as the communication protocol to be used when merging the cellular and Internet worlds, there is present no architecture for extending UPnP with mobility by using SIP. It is therefore desirable to have a system networking architecture that overcomes this limitation.

### BRIEF DESCRIPTION OF THE DRAWINGS

The present invention will become more fully understood from the detailed description and the accompanying drawings, wherein:

FIG. 1 is a high-level block diagram of one embodiment of architecture that supports UPnP applications on a mobile client without applications alteration;

FIG. 2 is a detailed block diagram at architecture that supports UPnP applications on a mobile client without applications alteration;

FIG. 3 is a block diagram of a UPnP mobility architecture that does not require a UPnP stack on a mobile client;

FIG. 4 is a detailed block diagram of a UPnP mobility architecture that does not require UPnP stack on a mobile client;

FIG. 5 is a block diagram of one embodiment of a UPnP-SIP protocol mapping principle and architecture's protocol layer diagram;

FIG. 6 is a block diagram of one embodiment of UPnP-SIP message interaction for mobile UPnP service registration and discovery;

FIG. 7 is a block diagram of one embodiment of UPnP-SIP message interaction for UPnP service discovery by a mobile client;

FIG. 8 is a block diagram of one embodiment of UPnP-SIP message interaction for mobile UPnP service control;

FIG. 9 is a block diagram of one embodiment of UPnP-SIP message interaction for UPnP service control by mobile client;

FIG. 10 is a block diagram of one embodiment of UPnP-SIP message interaction for mobile UPnP service eventing;

FIG. 11 is a block diagram of one embodiment of UPnP-SIP message interaction for UPnP service eventing by a mobile control point; and

FIG. 12 is a flow diagram of one method of a device sending a SIP message that is translated into a UPnP message in accordance with one embodiment of the invention.

### DETAILED DESCRIPTION OF THE PREFERRED EMBODIMENTS

The following description of the preferred embodiments is merely exemplary in nature and is in no way intended to limit the invention, its application, or uses. For purposes of clarity, the same reference numbers are used in the drawings to identify similar elements.

The present invention describes a plug and play (UPnP) mobility framework that extends UPnP beyond a local area network (LAN). This UPnP mobility framework is generally achieved through message translation between session initiation protocol (SIP) and UPnP.

One embodiment of the invention is briefly summarized below followed by a more detailed description of all of the various embodiments. One embodiment involves a method for extending UPnP messaging beyond a LAN. A proxy resides on the mobile device. The proxy includes at least one proxying agent such as a control proxying agent, a registration proxying agent, and/or an eventing proxying agent. At least one SIP message is translated into a UPnP message. For example, a SIP control message is translated by the control proxying agent into a UPnP control message.

Another example relates to a SIP registration message that is translated by the registration and service discovery proxying agent into a UPnP registration message, a UPnP service and discovery message, or a UPnP advertisement message.

Yet another example involves a SIP-based event-notification-driven service discovery message that is translated by the event proxying agent into a UPnP service discovery and registration message. The UPnP message is then sent over the LAN to the UPnP device. The UPnP device then responds to the UPnP message.

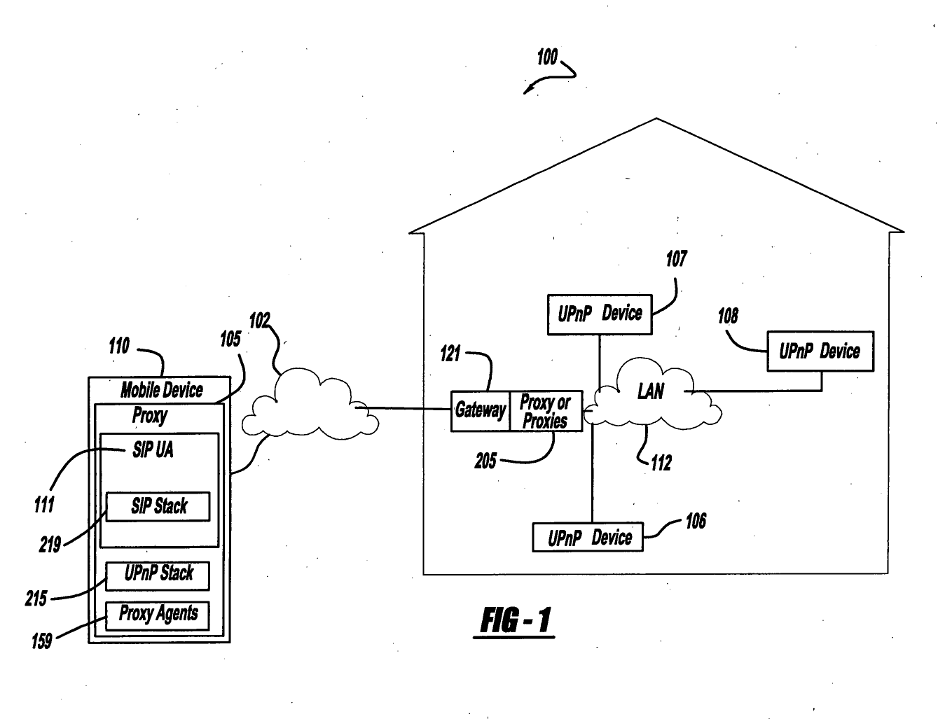

The first system 100 shown in FIG. 1 includes a mobile device (also referred to as a first device) 110 located beyond the LAN 112, a network gateway 121, a LAN 112, and UPnP devices (also referred to as second devices) 106-108. Each of these components is briefly described with respect to their function and the manner of interaction with each other.

The mobile device 110 includes a proxy 105. The proxy 105 translates messages between two application and network layer protocols. For example, when translating from UPnP to SIP frameworks and protocols, generally a portion of the UPnP layer protocols are substituted with SIP, or vice versa. To accomplish this task, the proxy 105 includes a SIP stack 219, a plurality of proxy agents 159, and a UPnP stack 215.

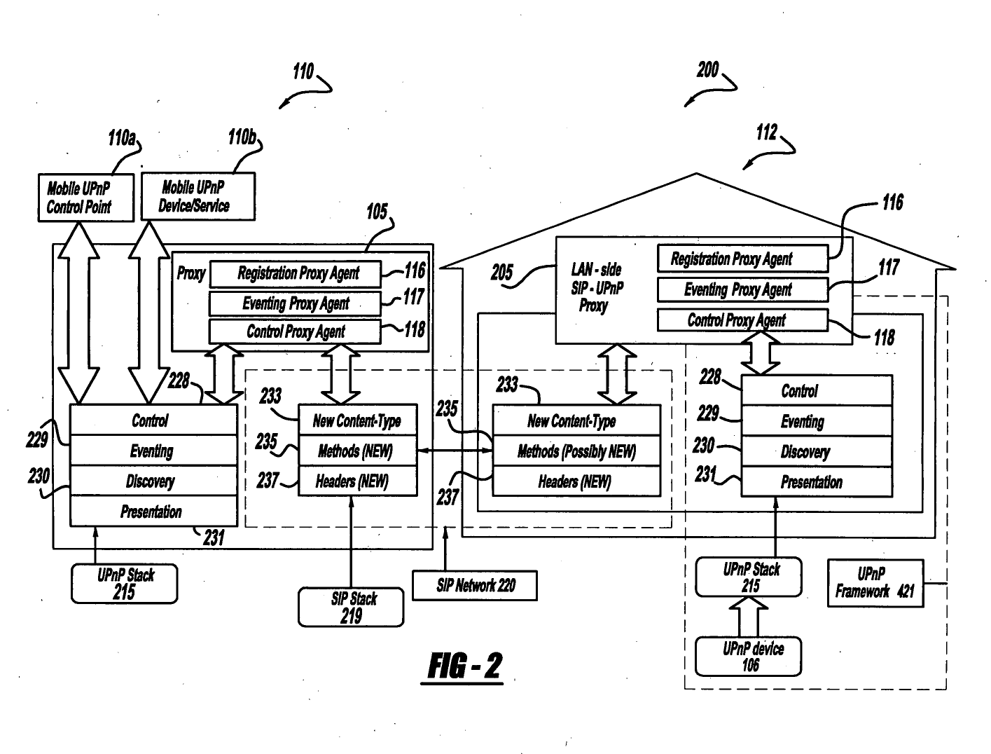

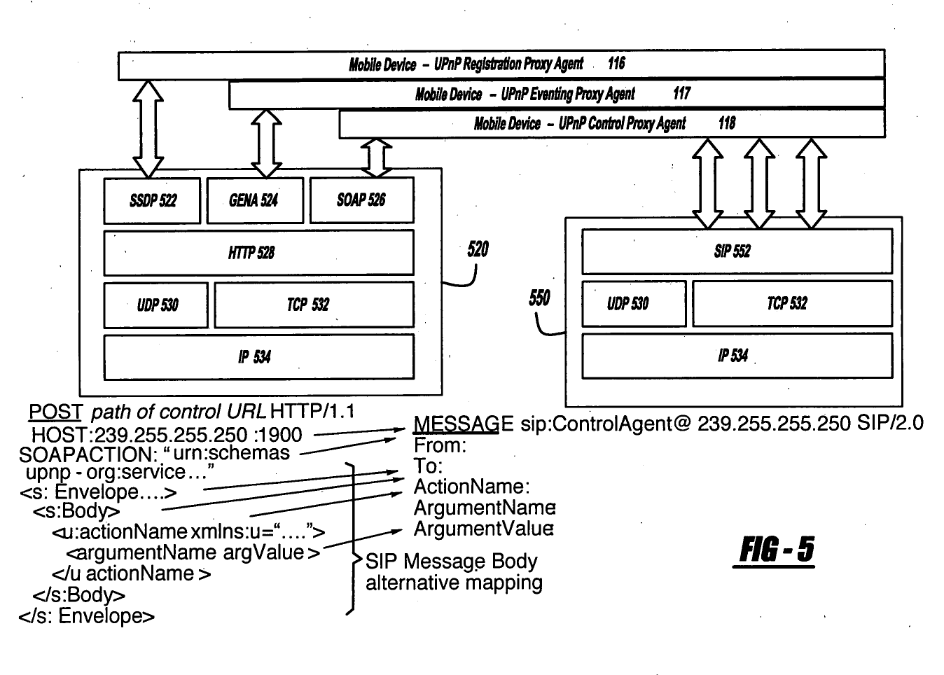

The SIP stack 219 is a group of layered protocols, such as that which is shown in FIG. 5. This group of layered protocols provides the basic connectivity for the mobile device 110 architecture. Referring briefly to FIG. 2, a more detailed system architectural view is shown, supporting UPnP applications on a mobile device in its native form. Mobile UPnP-SIP Proxy 105 and LAN-side UPnP-SIP proxy 205 both consist of a plurality of proxy agents 159.

The plurality of proxy agents 159 include a UPnP registration and service discovery proxy agent 116, a UPnP eventing proxy agent 117, and/or a UPnP control proxy agent 118. The UPnP registration and service discovery proxy agent 116 translates UPnP service discovery (e.g., advertise, search, response) messages into SIP service registration and eventing messages, enabling service discovery and registration between UPnP and SIP frameworks. The UPnP eventing proxy agent 117 translates eventing messages between SIP and UPnP frameworks and protocols, enabling UPnP state viable eventing and event moderation. The UPnP control proxy agent 118 translates device/service control messages between SIP and UPnP frameworks and protocols, enabling UPnP device control mobility.

The mobile device 110 also includes a UPnP stack 215. The UPnP stack 215 includes a group of layered protocols (e.g., SSDP, GENA) as is also shown in FIG. 5. Although the TCP/IP protocol suite and the HTTP typically provide the basic network connectivity for the UPnP device architecture, messages to and from the mobile device 110 need to be in SIP format to enable user mobility and other SIP features. The SIP UA is formed by the interaction between the SIP-UPnP proxy 105 and the SIP stack 219.

Messages between the mobile device 110 and the UPnP devices 106-108, are transmitted through the gateway 121. The gateway 121 interconnects the LAN 112 and the WAN networks.

The LAN-side SIP-UPnP proxy 205 optionally resides in the gateway 121 or immediately thereafter. The LAN-side SIP-UPnP proxy 205 translates messages between SIP and UPnP frameworks in an inverse and complimentary fashion to mobile SIP-UPnP proxy 105. For example, the LAN proxy 205 receives the SIP message from the mobile device 110. The LAN-side proxy 205 then translates this SIP message to a UPnP message through a UPnP registration and service discovery proxy agent 116, a UPnP eventing proxy agent 117, or a UPnP control proxy agent 118. The UPnP message is then transmitted from the LAN-side proxy 205 to a UPnP device 106-108 over the LAN. While system 100 has been described relative to a message that is sent from the mobile device 110 to one of the UPnP devices 106-108, skilled artisans understand that the message flow may be reversed.

The mobile device 110 or the UPnP devices 106-108 may serve as control points to a UPnP service. As previously described, a UPnP control point (CP) invokes an action on a UPnP service. A control point may discover devices, retrieve device and service descriptions, invoke actions on services, query for state variables, receive events from services, and other like tasks. Each of these processes is briefly described.

Discovering UPnP devices involves a search on a network to find at least one device that meets the search criteria, originated by the CP. The universal resource locator (URL) of a UPnP device that matches the search criteria is then, sent to the control point in response. The control point then uses this URL to retrieve the device or the service description documents. The device description document contains device information such as the name of the manufacturer, the model of the device, the serial number, a list of services provided by the device, and a list of embedded devices. In comparison, a service description document contains detailed information about the service, the actions or commands that it provides, relevant parameters, and a return values. Once a control point has discovered and retrieved the device and/or service description documents, the control point may control the device, subscribe to events sourced by the device's services, or retrieve the device's presentation page. The presentation page is the interface used to control the device, to change operational parameters, to view the device or service information, or for any other device specific functionality implemented by the manufacturer.

A query for a state variable is responded to by a service to provide access to its state variables. A state variable has a name type, optional default value, and optional constraint values. The state variables may trigger UPnP events when its value changes. An event allows a control point to monitor state changes in a device. The device's service notifies all registered control points of any changes in its state variables.

FIGS. 2 through 12 present details of the architecture that extends UPnP with mobility framework. FIG. 2 represents a detailed protocol stack information for the architecture shown in FIG. 1. Referring now to FIG. 2, a system 200 translates a message between SIP and UPnP frameworks and protocols. The system 200 includes a mobile device 110a, 110b and a UPnP device 106. The mobile device 110a, 110b may act either as a mobile UPnP control point 110a or a mobile UPnP device/service 110b. The mobile device 110 includes networking stacks such as a UPnP upper layer stacks 215 and a SIP protocol stack 219.

UPnP message payloads, like control message 228, an eventing message 229, a discovery message 230, and a presentation message 231 are proxied through the registration proxy agent 116, eventing proxy agent 117, or control proxy agent 118 into a SIP message. The SIP message may include newly defined content-type 233, a newly defined SIP method 235, or a SIP extension header 237. For example, the newly defined SIP extension header indicates the type of UPnP request and the destination of such request. The so constructed SIP message is then transmitted through the transport layer of the SIP stack 219 for the mobile device 110 over the SIP network 220.

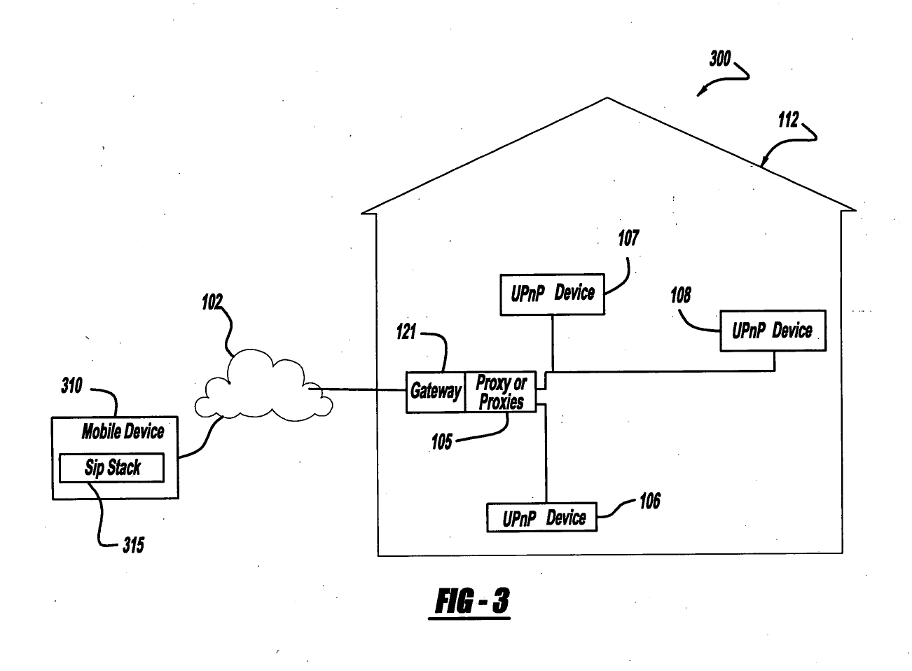

FIG. 3 illustrates a block diagram of a second system 300 that includes a mobile device 310 which lacks UPnP underlying communication protocols. In particular, while the mobile device 310 lacks such UPnP protocols as HTTPU, SSDP, it still possesses some upper layer UPnP functionality like ability to parse UPnP XML schema. There is still upper XML-parsing layers of UPnP layered architecture present in the mobile device 110 that allows for interpretation of a SIP message payloads. One illustration of this principle relates to a service description document. This is a XML structured document according to UPnP XML schema. While this information is parsed from the XML portion of SIP payload, the HTTP unicast, the HTTP multicast, and the GENA protocols are absent from mobile 310. Therefore, the critical XML service description, eventing and control documents are still capable of being interpreted with the limited UPnP capabilities of the mobile device 310.

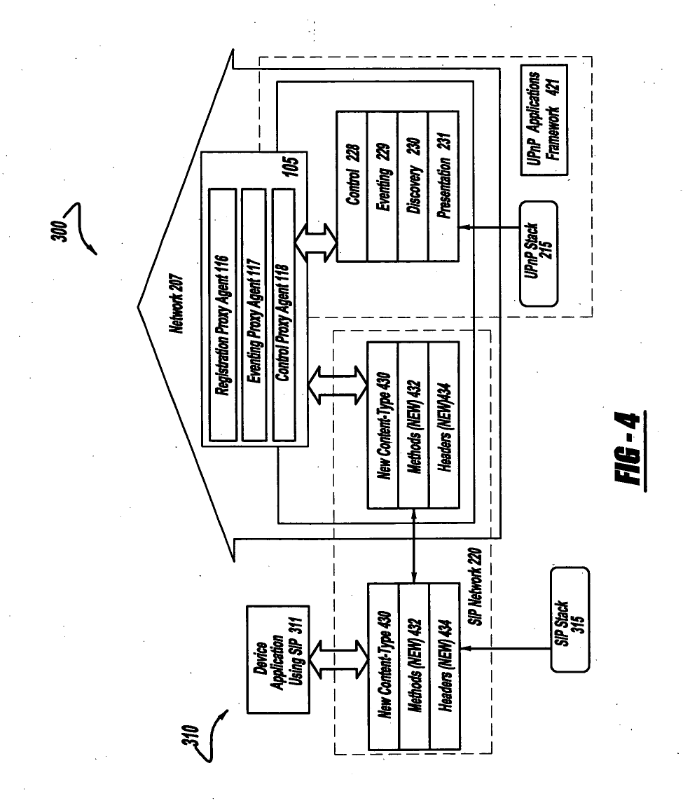

Referring now to FIG. 4 (which is a detailed protocol stack diagram of FIG. 3 architecture), the mobile device 310 includes a SIP stack 315 together with XML parsing discussed earlier. The SIP stack 315 includes SIP protocol extensions that relate to a new content-type 430, new SIP methods 432, and new SIP extension headers 434 for SIP messages. The content-type 430, the methods 432, the headers 434 are translated to a valid UPnP message by one of the proxying agents such as the registration proxy agent 116, the eventing proxy agent 117, and the control proxy agent 118. These proxying agents are all mapping informational components between SIP and UPnP protocols. In this embodiment, the SIP message is sent over the SIP network 220, while UPnP message is propagated within UPnP framework 421.

A comparison of the UPnP architecture protocol stack 520 to the SIP architecture protocol stack 550 FIG. 5 illustrates that the same IP network layers are used between the two architectures, but the application and transport layers differ. The UPnP architecture protocol stack 520 includes a simple service discovery protocol (SSDP) 522, a general event notification architecture (GENA) 524, the SOAP 526, a HTTP 528, a UDP 530, a TCP 532, and an IP 534. The SOAP 526 and GENA 524 are the protocol used for event subscription and notification.

The SIP layered architecture 550 includes a SIP 552, a UDP 530, a TCP 532 and a IP 534. SIP 552 carries and provides mobility to the UPnP elements of the UPnP message or an encapsulated UPnP message.

Generally, translating a UPnP message to a SIP message requires either a number of UPnP elements to be translated into the SIP header extensions or the UPnP message elements to be encapsulated into a SIP message body. FIG. 5, therefore, illustrates one example of a protocol mapping principle for mapping a UPnP control message to a SIP control message using SIP header extensions. Other similar techniques may also be used.

A UPnP control uses the simple object access protocol (SOAP). SOAP is a protocol that brings together XML and HTTP to provide web-based messaging and a remote procedure call mechanism. XML is used to express the contents of the message.

By parsing the elements of the structured UPnP XML message, a proxy 105 constructs the SIP message. The fields of the structured XML correspond to the new headers defined in SIP. In another embodiment, the entire portion of the XML on the left hand side of FIG. 5 could be placed inside a SIP message body as a text. New content type 430 FIG. 4 can then be defined for such SIP attachment.

In this embodiment, the control proxy agent 118 translates data from a control UPnP message to a SIP message carrying control information by mapping the UPnP elements to the SIP message in the fashion described above. The other types of UPnP messages are proxied into different types of SIP messages through one of the proxy agents 116-118.

Turning now to the actual mapping of the UPnP data to the SIP data, as shown in this example, UPnP elements are mapped to the SIP header extensions, which allows another SIP proxy agent to review the SIP header above to properly handle the message. The SOAP XML elements directly translates to the SIP extension headers as shown by the arrows in FIG. 5. For example, the U:actionName is mapped into ActionName header of the SIP message. Alternatively, the body of the UPnP message is mapped into the body of the SIP message, as also shown in FIG. 5.

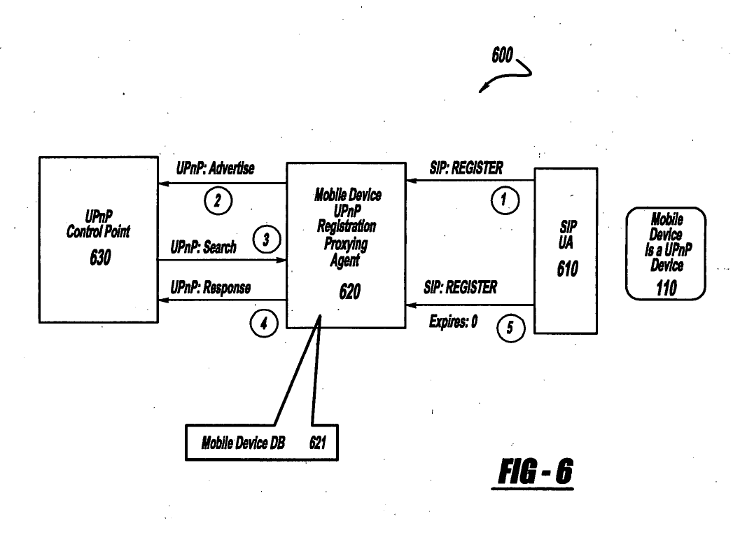

FIGS. 6-11 are timing diagrams that show the SIP-UPnP message interaction using several proxying agents for different types of UPnP messages. For the sake of brevity, the types of messages are previously defined and are not repeated below. FIG. 6 illustrates a message interaction diagram 600 for UPnP registration. Here, the mobile device 110 exposes a UPnP service via SIP to a UPnP control point 630. The mobile device 110 includes a SIP UA 610 that transmits a SIP:Register message, denoted as 1, to the mobile device's UPnP registration proxying agent 620. The SIP register message carries the URL of the mobile device 110.

The mobile device UPnP registration proxying agent 620 translates the SIP register message to a UPnP advertise message denoted as 2. This message is then sent to the UPnP control point 630. Mobile device database 621 is updated within 620 as a result of SIP:Register request.

The UPnP control point 630 can also send a search message, denoted as 3, to the registration proxying agent 620. The search message is a query for a registered UPnP service that may be invoked on a mobile device. The mobile device UPnP registration proxying agent 620 then accesses the mobile device database (DB) 621 for current service registrations and sends a UPnP response, denoted as 4, to the UPnP control point 630. This response indicates whether a UPnP service is available on the mobile device 110. The SIP UA 610 may also send another SIP registration message, denoted as 5, that cancels the registration of the mobile device 110 UPnP service.

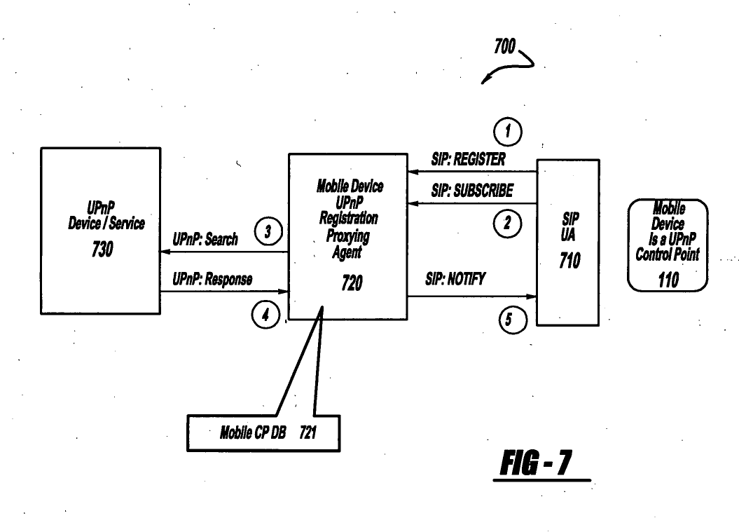

FIG. 7 illustrates another SIP-UPnP message interaction 700 of a UPnP registration SIP proxying principle. In this embodiment, the mobile device 110 serves as a control point and a LAN-based UPnP device 730 exposes a UPnP service. In this embodiment, the SIP UA 710, residing on the mobile device 110, generates a SIP:Register message, denoted as 1, that is transmitted to the registration proxying agent 720. The SIP UA 710 also sends a SIP Subscribe message, denoted as 2, to the registration proxying agent 720 in order to receive SIP event notifications of UPnP service discovery and availability. The mobile device's UPnP registration proxying agent 720 translates the SIP Subscribe message, denoted as 2, to a UPnP Search message, denoted as 3, issued toward a UPnP device/service 730 in order to discover its services. Thereafter, the UPnP device/service 730 sends a UPnP response, denoted as 4, to the UPnP registration proxying agent 720. The UPnP response, denoted as 4, indicates whether the UPnP device/service 730 meets the search criteria of the UPnP service discovery message, denoted as 3. The UPnP registration proxying agent then translates and sends a SIP notify message, denoted as 5, to SIP UA 710. The SIP notify message, denoted as 5, indicates whether the target service has been found.

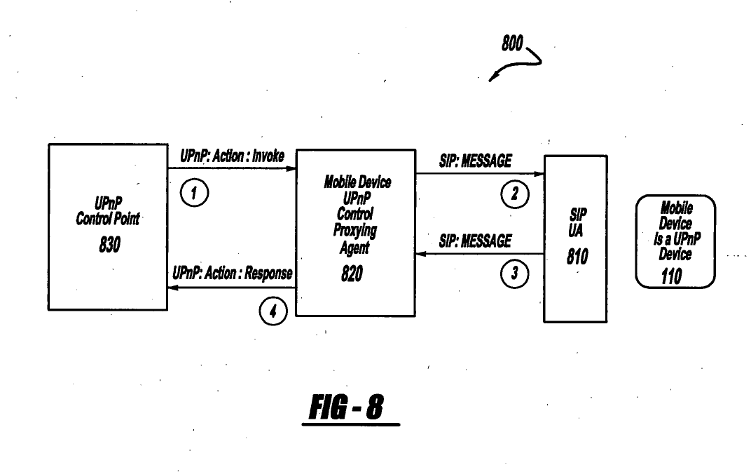

FIG. 8 illustrates a SIP-UPnP message interaction flow 800 for a UPnP control SIP proxying principle. In this embodiment, the UPnP control point 830 sends a UPnP:Action:Invoke message, denoted as 1, to the Mobile Device UPnP control proxying agent 820. Thereafter, the control proxying agent 820 translates this message to a SIP:Message carrying control information, denoted as 2, which is sent to the SIP UA 810. In response, the SIP UA 810 then sends a SIP:Message, denoted as 3, carrying control action response to the UPnP control proxying agent 820. The UPnP control proxying agent 820 translates this SIP message to a UPnP action response, denoted as 4, to the UPnP control point 830.

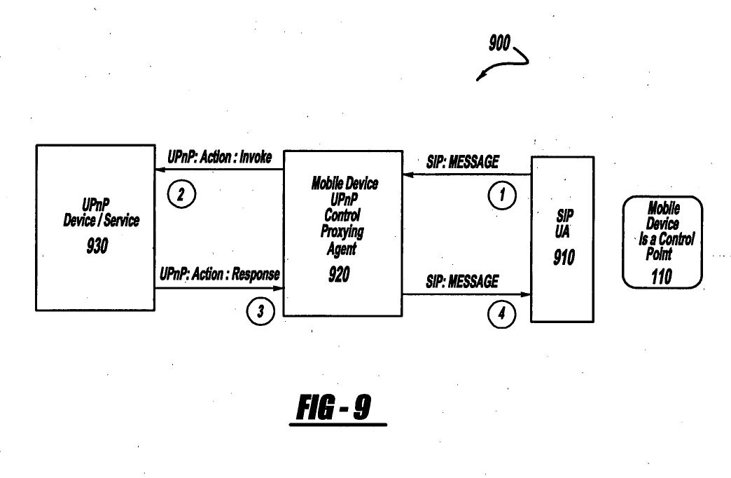

FIG. 9 illustrates a SIP-UPnP message interaction flow 900 for a UPnP control SIP proxying principle. Here, the mobile device 110 is the UPnP control point. In this embodiment, the SIP UA 910 sends a SIP:Message method, denoted as 1, to a mobile device UPnP control proxying agent 920. The control proxying agent 920 translates the SIP message to a UPnP:Action:Invoke message. Thereafter, the mobile device UPnP control proxying agent 920 sends a UPnP:Action:Invoke message, denoted as 2, to invoke an action of the UPnP device/service 930. After the action execution, The UPnP device/service 930 sends a UPnP action response, denoted as 3, to a mobile UPnP control proxying agent 920. By this response, the UPnP device/service 930 indicates whether it was able to perform the action successfully and return any associated output data. Data from this message is translated to a SIP:Message, denoted as 4, that is then sent from the control proxying agent 920 to the SIP UA 910.

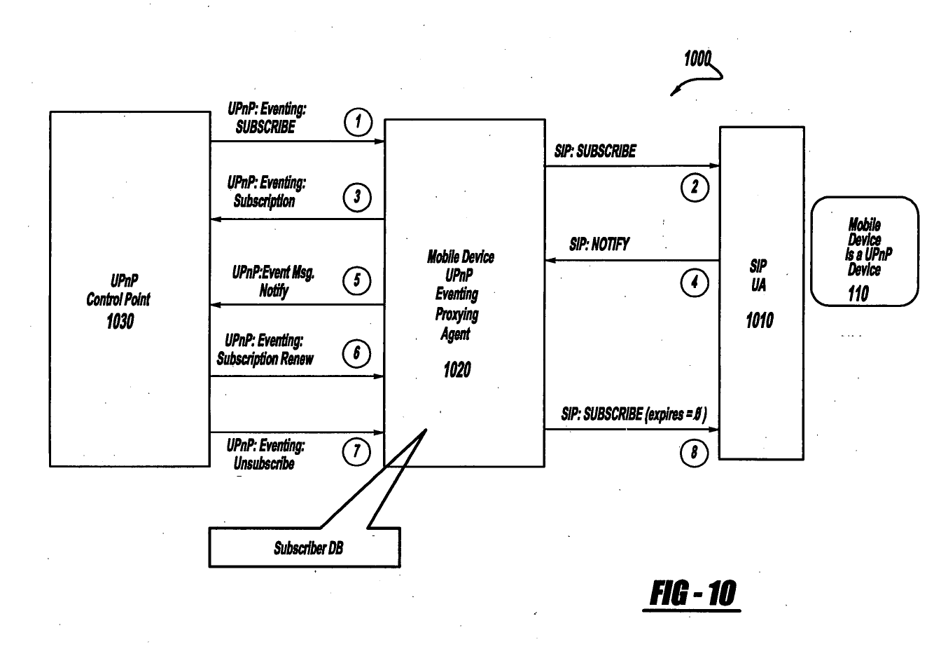

FIG. 10 illustrates a UPnP-SIP message flow to support UPnP eventing proxying principle 1000. The UPnP control point 1030 subscribes to UPnP eventing sending a UPnP:Eventing:Subscribe message, denoted as 1, to the eventing proxying agent 1020. The mobile device UPnP eventing proxying agent 1020 then translates this message to SIP and sends a SIP:Subscribe method message, denoted as 2, to SIP UA1010. The mobile device UPnP eventing proxying agent 1020 also sends a UPnP eventing subscription notification, denoted as 3, to UPnP control point 1030 to indicate whether subscription was successful or not.

Once this event occurs, the SIP UA 1010 sends a SIP:Notify message, denoted as 4, to the UPnP eventing proxying agent 1020. The SIP notify message, denoted as 4, indicates the status of the event generated by the UPnP device 110. The UPnP eventing proxying agent 1020 translates this message and then sends a UPnP:Event message Notify, denoted as 5, to the UPnP control point 1030. The UPnP eventing Subscription:Renew message, denoted as 6, can also be sent from UPnP control point 1030 to the eventing proxying agent 1020 in order to update UPnP event subscriptions. The UPnP control point 1030 sends an UPnP:Eventing:Unsubscribe message, denoted as 7, to eventing proxying agent 1020 to terminate even subscriptions. As a result, eventing proxying agent 1020 sends a SIP:Subscribe message with “Expires” header set to zero [null], denoted as 8, that cancels the event subscription.

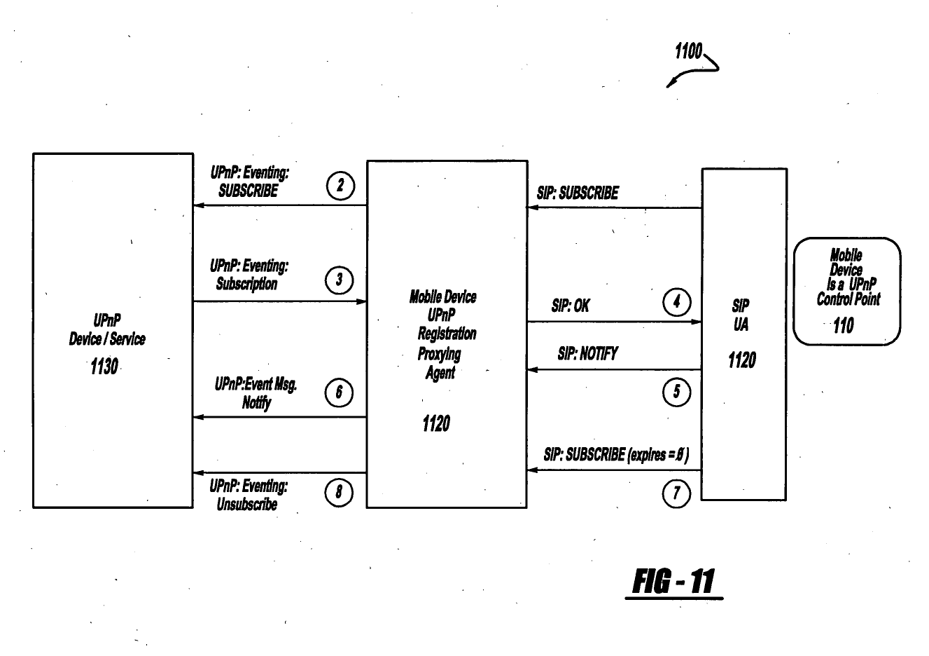

FIG. 11 illustrates a message interaction flow 1100 of a UPnP eventing—SIP proxying principle involving a mobile device 110, which serves as a UPnP control point. In this embodiment, SIP UA1110 sends a SIP:Subscribe message, denoted as 1, to registration proxying agent 1120, in order to subscribe to some UPnP event of interest. The registration proxying agent 1120 then translates this message into a UPnP:Eventing:Subscribe message, denoted as 2, to the UPnP device/service 1130 to facilitate subscription. The UPnP device/service 1130 then sends a UPnP eventing subscription notification message, denoted as 3, to the registration proxying agent 1120. The UPnP eventing subscription notification message, denoted as 3, is translated to SIP by the registration proxying agent 1120.

As a result, a SIP OK message, denoted as 4, is then sent from the registration proxying agent 1120 to SIP UA 1110. Once the event occurs, the SIP UA 1110 sends a SIP notify message, denoted as 5, to the registration proxying agent 1120. Registration proxying agent 1120 then translates SIP event into UPnP event and sends a UPnP:Event Notify, denoted as 6, to the UPnP device/service. The SIP UA1110 may send the SIP:Subscribe message (expires=0), denoted as 7, to the registration proxying agent 1120 to unsubscribe from event notification. In response, the UPnP registration proxying agent 1120 then sends a UPnP eventing unsubscribe message, denoted as 8, to the UPnP device/service 1130.

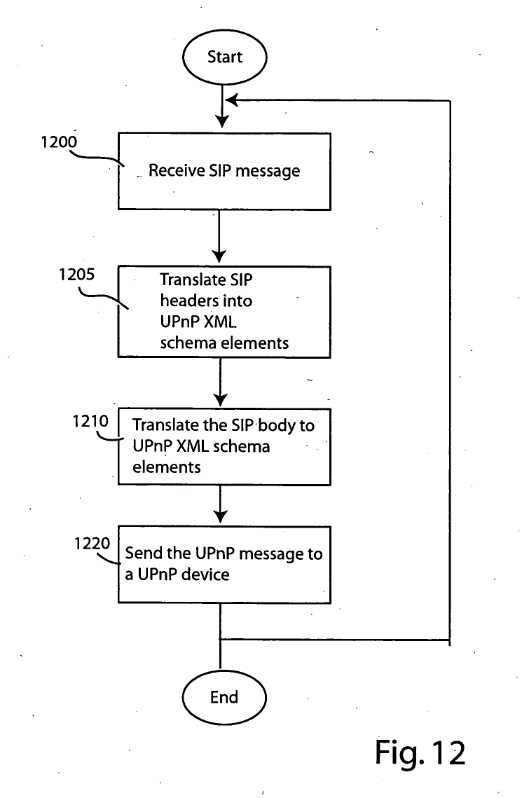

FIG. 12 is a flow diagram of one method of translating a message from SIP to UPnP, upon receiving SIP message by proxying agent. A SIP message is received at operation 1200. The SIP message is translated to UPnP message by step 1205, translating all related SIP header values into corresponding UPnP message XML schema elements. Subsequently, in step 1210, SIP message body is translated into UPnP message XML elements. See also FIG. 5 for mapping details. The UPnP message is transmitted from the corresponding proxying agent to a UPnP device at operation 1220.

It will be appreciated that more or fewer processes may be incorporated into the methods described herein without departing from the scope of the invention and that no particular order is implied by the arrangement of blocks shown and described herein. Skilled artisans will appreciate that the methods may be embodied in machine-executable instructions (e.g., software). The instructions can be used to cause a general-purpose or special-purpose processor that is programmed with the instructions to perform the operations described. Alternatively, the operations may be performed by specific hardware components that contain hard-wired logic for performing the operations, or by any combination of programmed computer components and custom hardware components.

The methods may be provided as a computer program product that may include a machine-readable medium having stored thereon instructions which may be used to program a computer (or other mobile devices) to perform the methods. For the purposes of this specification, the terms “machine-readable medium” includes any medium that is capable of storing or encoding a sequence of instructions for execution by the machine and that cause the machine to perform any one of the methodologies of the present invention. The term “machine-readable medium” includes, but is not be limited to, solid-state memories, optical and magnetic disks, and carrier wave signals.

The present invention may be implemented through various architectures such as a peer-to-peer network, a client/server network, or a master/slave network. Skilled artisans appreciate that any one of these networks may be involved at any instant in implementing techniques of the present invention with respect to FIGS. 2-12. For example, UPnP messaging can be deployed over LAN, WLAN, Tonneled-LAN, IPub-mobility-enabled secure networks, etc.

In the preceding detailed description, the invention is described with reference to specific embodiments thereof. It will, however, be evident that various modifications and changes may be made thereto without departing from the broader spirit and scope of the invention as set forth in the claims. The specification and drawings are, accordingly, to be regarded in an illustrative rather than a restrictive sense.

What is claimed is:

1. A method for extending UPnP device architecture beyond a LAN comprising:
providing a mobile device with SIP protocol stack;
associating a proxy with the mobile device, the proxy includes at least one of a control proxying agent, a registration proxying agent, and an eventing proxying agent;
translating at least one SIP message into a UPnP message such that at least one of:
(a) a SIP:Message method-based control is translated by the control proxying agent into a UPnP:Control message;
(b) a SIP registration message is translated by the registration proxying agent into at least one of UPnP registration message, a UPnP service and discovery message, and a UPnP advertisement message; and
(c) a SIP-based event-notification-driven service discovery message is translated by the event proxying agent into a UPnP service discovery and registration message; and
sending the UPnP message over a UPnP network.

2. A method for extending UPnP messaging beyond a LAN comprising:
providing a mobile device with SIP protocol stack;
associating a proxy with mobile device, the proxy includes at least one of a control proxying agent, a registration proxying agent, and an eventing proxying agent;
translating at least one UPnP message into a SIP message such that at least one of:
(a) a UPnP control message is translated by the control proxying agent into a SIP control message;
(b) a UPnP registration message is translated by the registration proxying agent into SIP registration message; and
(c) a UPnP service discovery and registration message is translated by the event proxying agent into a SIP-based event-notification-driven service discovery message; and
sending the SIP message over a network to a mobile device,
wherein the SIP message carries UPnP elements of at least one UPnP message.

3. A method for extending UPnP messaging beyond a LAN comprising:
providing a mobile device that lacks UPnP underlying communications protocols;
associating a proxy with one of a UPnP device and a gateway between the mobile device and the UPnP device, the proxy includes a control proxying agent, a registration proxying agent, and an eventing proxying agent;
translating at least one SIP message into a UPnP message such that at least one of:
(a) a SIP control message is translated by the control proxying agent into a UPnP control message;
(b) a SIP registration message is translated by the registration proxying agent into UPnP registration message; and
(c) a SIP-based event-notification-driven service discovery message is translated by the event proxying agent into a UPnP service discovery and registration message;
sending the UPnP message over a UPnP network.

4. A method comprising:
providing a mobile device;
associating a proxy with the mobile device;
generating a SIP message from the mobile device;
translating the SIP message to a UPnP message by a LAN proxy; and
transmitting the UPnP message from the LAN proxy to a UPnP device.

5. A method comprising:
providing a mobile device;
generating a SIP register message from the mobile device; and
translating the SIP register message to a UPnP advertise message through a registration proxying agent associated with the mobile device.

6. The method of claim 5 further comprising:
generating a UPnP search message from a control point to the registration proxying agent.

7. The method of claim 5 further comprising:
generating a UPnP response from the registration proxying agent to the control point.

8. The method of claim 5 further comprising:
generating a SIP deregister message from the mobile device to the registration proxying agent.

9. A method comprising:
providing a mobile control point;
associating a registration proxying agent with the mobile control point;
generating a SIP register message from the mobile control point to the registration proxying agent;
generating a SIP subscribe message from the mobile control point to the registration proxying agent;
translating the SIP subscribe message to a UPnP search message by the registration proxying agent;
sending the UPnP search message to the UPnP service;
sending a UPnP response from the UPnP service to the registration proxying agent; and
translating the UPnP response to a SIP notify message by the registration proxying agent.

10. A method comprising:
providing a mobile device;
associating a control proxying agent with the mobile device;
generating a UPnP control message from the control point to the control proxying agent; and
translating the UPnP control point to a SIP register message by the control proxying agent.

11. The method of claim 10 further comprising:
sending the SIP register message to the mobile device from the control proxying agent.

12. The method of claim 11 further comprising:
generating a SIP message from the mobile device to the control proxying agent.

13. The method of claim 12 further comprising:
translating the SIP message to a UPnP response by the control proxying agent.

14. The method of claim 13 further comprising:
sending the UPnP response to the control point by the control proxying agent.

15. A method comprising:
providing a mobile control point;
associating a control proxying agent with the mobile device;
generating a first SIP message from the mobile control point to the control proxying agent; and
translating the first SIP message to a UPnP action message by the control proxying agent.

16. The method of claim 15 further comprising:
sending the UPnP action message over a network to the mobile device from the control proxying agent.

17. The method of claim 16, further comprising:
generating a UPnP action response message from the mobile device to the control proxying agent.

18. The method of claim 17 further comprising:
translating the UPnP action response message to a second SIP message by the control proxying agent.

19. The method of claim 18 further comprising:
sending the second SIP message to the control point by the control proxying agent.

20. A method comprising:
providing a control point;
associating an eventing proxying agent with the control point;
generating a UPnP eventing message from the control point to the eventing proxying agent;
translating the UPnP eventing message to a SIP subscribe message by the eventing proxying agent; and
transmitting the UPnP eventing message to a mobile device.

21. A method comprising:
providing a remote first device;
generating a SIP message from the first device;
sending the message to a LAN;
translating the SIP message to a UPnP message through a proxy on the LAN; and
transmitting the UPnP message to a second device.

22. A method comprising:
generating a UPnP message from a device on a LAN;
transmitting the UPnP device to a proxy on a gateway;
translating the UPnP message to a SIP message through the proxy; and
transmitting the SIP message to a mobile device.

23. The method of claim 22 further comprising:
translating the SIP message to a UPnP message through a proxy residing on the mobile device.
